(19) United States
(12) Patent Application Publication
(10) Pub. No.: US 2007/0218443 A1
(43) Pub. Date: Sep. 20, 2007

(54) Tactile structures

(76) Inventor: Anthony Bondi, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 11/366,963

(22) Filed: Mar. 1, 2006

(51) Int. Cl. G09B 19/00

(52) U.S. Cl. 434/247

(57) ABSTRACT

Described is a tactile structure having a plurality of tactile elements, the tactile elements providing tactile sensations for at least a portion of a user's body that is actively engaging the tactile protrusions. Furthermore, a plurality of tactile structures can be assembled to create a tactile system having multiple passageways.

### FIELD OF THE INVENTION

The embodiments of the present invention relate to tactile structures, more specifically, a tactile structure comprising tactile elements operable to provide an interactive tactile experience for a user.

### BACKGROUND

Play structures and playground equipment such as swing sets, monkey bars, seesaws, slides and the like are well known in the art. However, many of these play structures are directed to physical activities and are less concerned with providing an interactive tactile experience for a user. Tactile experiences have long been known to benefit children and young adults. Moreover, adults enjoy tactile experiences when given the opportunity to participate.

The patent literature includes references directed to children's playground equipment. For example, U.S. Pat. No. 6,641,139 to Lamberti et al. discloses a game utilizing enclosed walls to provide an internal chamber whereby points are given to players for striking a series of targets mounted on the walls using a ball. The game functions to improve a child's hand-eye coordination. Likewise, U.S. Pat. No. 5,405,304 to Petersheim et al. discloses a multiple pathway, play apparatus having suspended nets for climbing and crawling. The apparatus functions to improve a child's climbing and balancing skills. Neither example discloses an apparatus for providing a tactile experience for the user.

Thus, there exists a need for a tactile structure that provides a user with an interactive tactile experience.

### SUMMARY

Accordingly, one embodiment of the present invention is a tactile structure that may be maintained on a surface, the tactile structure comprising a plurality of textured protrusions, the textured protrusions operable to provide an interactive tactile experience for at least a portion of a user's body that is actively engaging the textured protrusions. In another embodiment, the tactile structure comprises a substantially enclosed passageway having a plurality of textured protrusions extending into the substantially enclosed passageway, the textured protrusions operable to provide an interactive tactile experience for at least a portion of a user's body that is actively engaging the textured protrusions.

Other variations, embodiments and features of the present invention will become evident from the following detailed description, drawings and claims.

### BRIEF DESCRIPTION OF THE DRAWINGS

FIG. 1 illustrates a perspective view of a tactile structure;

FIG. 2 illustrates a perspective view of another tactile structure; and

FIG. 3 illustrates a perspective view of a tactile system.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

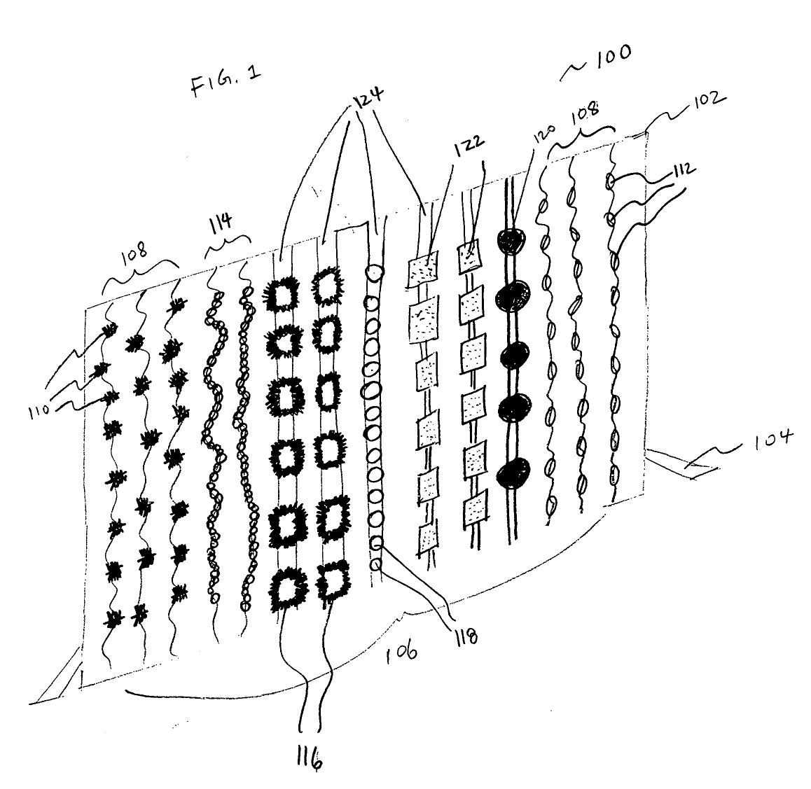

Initial reference is made to FIG. 1, which illustrates a perspective view of a tactile structure 100 according to an embodiment of the present invention. The tactile structure 100 includes a grid or framework 102 thereby allowing the tactile structure 100 to be positioned, situated or mounted on a surface such as a wall. The framework 102 design also allows the tactile structure 100 to be mounted to a ceiling or placed on a floor. The tactile structure 100 can also be freestanding if the framework 102 is maintained with support structures 104 or other means. Although the tactile structure 100 is shown rectangular in shape, it can be fabricated in a variety of polygonal shapes and sizes including but not limited to squares and circles.

The tactile structure 100 comprises a plurality of textured protrusions 106. The features and functions of textured protrusions 106 are further described in a commonly owned U.S. Pat. No. 6,464,619 entitled “Tactile Play Structure,” Ser. No. 09/540,725, filed Mar. 31, 2000, which is incorporated herein by reference in its entirety for all purposes. One type of textured protrusion 106 is a streamer 108 having feathers 110 or beads/marbles 112. The streamer 108 can be constructed of any flexible material including but not limited to bead chains, plastic strips, or the like. The feathers 110 can be from birds or made of plastic or the like having soft/flexible properties, while the beads/marbles 112 contain openings to facilitate mounting on the streamer 108. Another type of textured protrusion 106 includes ball chains 114 and attachments thereof. Ball chains 114 and attachments are preferred because they are relatively strong and substantially lightweight. Furthermore, because of their swiveling ability, ball chains 114 and attachments are less likely to tangle or kink. Other types of textured protrusions 106 include feather dusters 116, brushes/bristles or sponges 122, and balls 120 may be mounted on support posts 124 or similar devices. The support posts 124 can be constructed of any material including but not limited to wood, plastic, or the like. The types of textured protrusions 106 on a support post 124 can be uniform or comprise a mixed variety, while the exact number of textured protrusions 106 can also be fixed or vary and should not limit the scope of the present invention. It should be noted that the textured protrusions 106 could include any texture known in the art and should not be limited to the examples presented herein. In addition, the textured protrusions 106 can be mounted on any material known in the art and should not be limited to the examples presented herein.

The textured protrusions 106 can also be clustered with the intent of providing tactile or touch-based sensations for a portion of a user's body that is actively engaging the tactile structure 100. In other words, the user is then able to experience a variety of tactile or touch-based sensations as he or she touches each textured protrusion 106. For example, when the tactile structure 100 is mounted on a wall, the user leaning up or moving against the wall actively engages the tactile protrusions 106 because the user is actively touching or consciously applying pressure against the tactile protrusions 106. In contrast, passive engagement is a prone or sedentary activity such as when a chair or bed is provided and a user passively sits on such chair or passively lies on such bed. With active engagement, the portion of the user's body (e.g. hand or foot) that is physically contacting the textured protrusions 106 experiences different physical sensations depending on whether the portion of the body is touching feather dusters 116, brushes/bristles or sponges 122, or feathers 110. As a user moves along the tactile structure 100 (moves along the wall), the user experiences different tactile sensations as the portion of the body moves among the variety of textured protrusions 106. Likewise, the same tactile sensation can be experienced by a user when he or she walks, kneels or crawls through the tactile structure 100 placed on the floor or mounted to a ceiling.

Although the textured protrusions 106 have been illustrated as inanimate objects statically situated on the tactile structure 100, the textured protrusions 106 can also be animated by electronic motors (not shown). In other words, the textured protrusions 106 can be powered by electricity or other electronics to actively provide tactile stimulations to a portion of a user's body that is actively engaging the tactile structure 100.

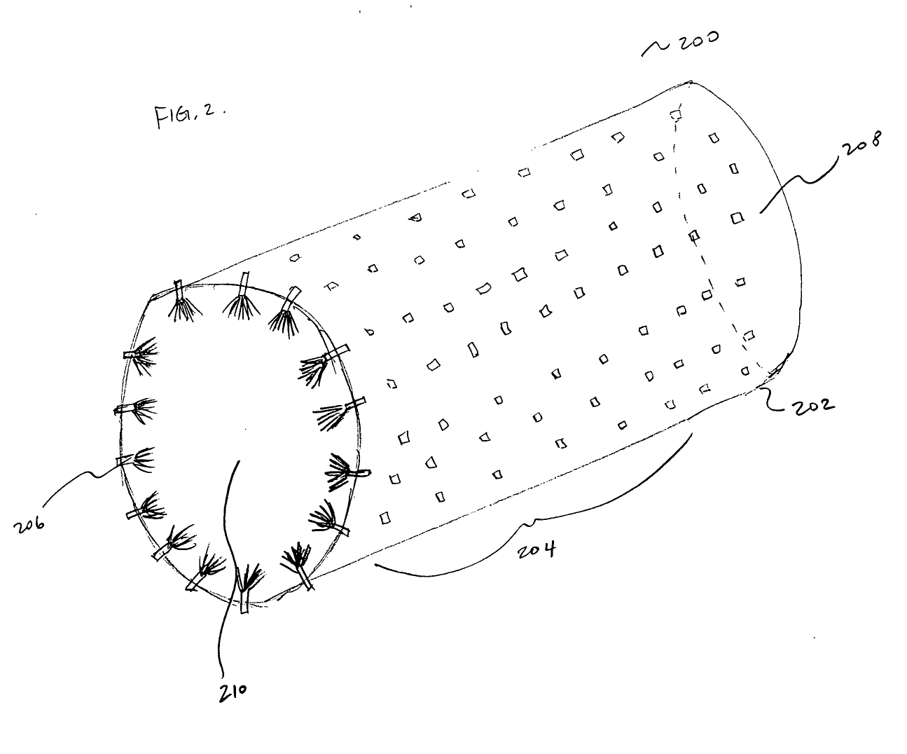

Reference is now made to FIG. 2, which illustrates a perspective view of a tactile structure 200 according to another embodiment of the present invention. The tactile structure 200 includes a substantially enclosed passageway 202 containing a plurality of textured protrusions 204, similar to those described above, throughout its length. The textured protrusions 204 as illustrated in the figure are feathered dusters 206. Although the substantially enclosed passageway 202 is shaped like a cylinder having two openings 208, 210, the tactile structure 200 can take on any shape including but not limited to cubes, rectangular prisms and spheres. The substantially enclosed passageway 202 can also be any tunnels, single-sided units, or corridors.

In use, when a user traverses the substantially enclosed passageway 202, whether by walking, crawling, kneeling or the like, the user will experience a variety of tactile sensations as he or she passes each textured protrusion 204. Additionally, depending on the size of the passageway 202, the tactile structure 200 can provide tactile sensations to the user's entire body. In other words, if the passageway 202 is narrow enough, a user crawling through it will engage the textured protrusions 204 with all parts of his or her body and experience active tactile sensation from head to toe.

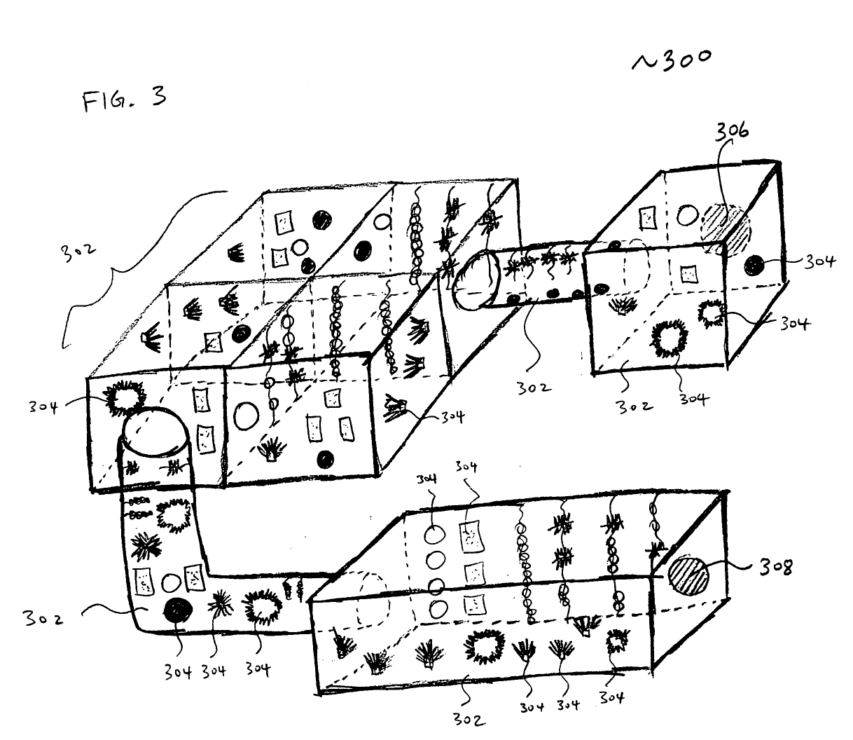

Reference is now made to FIG. 3, which illustrates a perspective view of a tactile system 300 constructed of a plurality of tactile structures 302 interconnected or placed adjacent to one another. The tactile structures 302 and the textured protrusions 304 contained therein are similar to those as previously described. Although only two openings 306, 308 are illustrated in the tactile system 300, there can be as many or as few openings as desired.

Although the invention has been described in detail with reference to several embodiments, additional variations and modifications exist within the scope and spirit of the invention as described and defined in the following claims.

I claim:

1. A tactile structure that may be maintained on a surface, the tactile structure comprising:
a plurality of textured protrusions, the textured protrusions operable to provide an interactive tactile experience for at least a portion of a user's body that is actively engaging the textured protrusions.

2. The tactile structure of claim 1, wherein the surface includes a wall, ceiling or floor.

3. The tactile structure of claim 1, further comprising a plurality of streamers.

4. The tactile structure of claim 3, wherein the streamers are bead chains, plastic strips or ball chains.

5. The tactile structure of claim 1, wherein the textured protrusions are spherical.

6. The tactile structure of claim 1, wherein the textured protrusions comprise feathers, feather dusters, fibrous brushes or bristles or sponges, balls, beads and marbles.

7. The tactile structure of claim 1, further comprising a motor for electronically driving the textured protrusions.

8. A free-standing tactile structure, the tactile structure comprising:
a support structure; and
a plurality of textured protrusions, the textured protrusions operable to provide an interactive tactile experience for at least a portion of a user's body that is actively engaging the textured protrusions.

9. The tactile structure of claim 8, further comprising a plurality of streamers.

10. The tactile structure of claim 9, wherein the streamers are bead chains, plastic strips or ball chains.

11. The tactile structure of claim 8, wherein the textured protrusions are spherical.

12. The tactile structure of claim 8, wherein the textured protrusions comprise feathers, feather dusters, fibrous brushes or bristles or sponges, balls, beads and marbles.

13. The tactile structure of claim 8, wherein the textured protrusions are electronically driven.

14. A tactile structure, comprising:
a substantially enclosed passageway; and
a plurality of textured protrusions extending into the substantially enclosed passageway, the textured protrusions for providing an interactive tactile experience for at least a portion of a user's body that is actively engaging the textured protrusions.

15. The tactile structure of claim 14, further comprising a plurality of streamers.

16. The tactile structure of claim 15, wherein the streamers are bead chains, plastic strips or ball chains.

17. The tactile structure of claim 14, wherein the textured protrusions are spherical.

18. The tactile structure of claim 14, wherein the textured protrusions comprise feathers, feather dusters, fibrous brushes or bristles or sponges, balls, beads and marbles.

19. The tactile structure of claim 14, wherein the textured protrusions are electronically driven.

20. A tactile system, comprising:
a plurality of tactile structures, each tactile structure comprising:
a substantially enclosed passageway; and
a plurality of textured protrusions extending into each substantially enclosed passageway, the textured protrusions for providing an interactive tactile experience for at least a portion of a user's body that is actively engaging the textured protrusion.

21. The tactile system of claim 20, further comprising a plurality of streamers.

22. The tactile system of claim 21, wherein the streamers are bead chains, plastic strips or ball chains.

23. The tactile system of claim 20, wherein the textured protrusions are spherical.

24. The tactile system of claim 20, wherein the textured protrusions comprise feathers, feather dusters, fibrous brushes or bristles or sponges, balls, beads and marbles.

25. The tactile system of claim 20, wherein the textured protrusions are electronically driven.
